(19) United States
(12) Patent Application Publication
(10) Pub. No.: US 2006/0092006 A1
(43) Pub. Date: May 4, 2006

(54) Device for monitoring a member on a motor vehicle, and a system comprising a member and a device for monitoring such a member

(76) Inventor: Jerome Grando, Vertrieu (FR)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/185,276

(22) Filed: Jul. 19, 2005

(30) Foreign Application Priority Data
Jul. 19, 2004 (FR) 0407988

(51) Int. Cl. B60Q 1/00; G08B 21/00

(52) U.S. Cl. 340/438; 340/686.1; 340/679

(57) ABSTRACT

The present invention relates to a device for monitoring a member that is stationary relative to a motor vehicle, the member having at least one position for proper operation, and a position in which it does not operate properly. The device comprises: measurement means suitable for measuring a geometrical magnitude characteristic of the position of at least a portion of the member relative to another stationary member of the vehicle, and for delivering a signal; comparator means connected to the measurement means and suitable for comparing the signal with a set of reference signals corresponding to at least one position for proper operation, said set being stored in the comparator means and supplying a positive result when the measured signal forms part of the set of reference signals, and otherwise supplying a negative result; and warning means connected to the comparator means and suitable for triggering a malfunction alert when the result supplied by the comparator means is negative.

The present invention relates to a device for monitoring a member on a motor vehicle and a system comprising both a member and a device for monitoring such a member.

### BACKGROUND OF THE INVENTION

It is known that present-day motor vehicles include more and more members that need to be positioned on the vehicle very accurately in order to ensure proper operation.

For example, there are detector systems for the purpose of improving the safety of passengers or of pedestrians, or indeed for avoiding damage to the vehicle.

On detecting an impact or an obstacle, such detector systems trigger an action for avoiding danger, such as, for example, deploying an airbag or issuing a sound signal to warn the driver that the vehicle is about to enter into collision with an obstacle.

It is very important, particularly for systems that ensure passenger or pedestrian safety, that such detector systems operate properly at all times throughout the lifetime of the vehicle, in particular after a relatively small impact that has not damaged the outside of the vehicle but that might have displaced one of these systems, without the driver noticing.

However since such systems are generally not highly visible from the outside of the vehicle, it is necessary for them to be inspected regularly by the owner, and since they are relatively inaccessible, that generally requires vehicle parts to be dismantled by professionals, which is expensive. Such inspection generally consists in verifying that the systems are properly positioned on the vehicle after an impact.

In addition to detector systems, it is also necessary to verify the positioning of other members that are not visible from the outside of the vehicle in order to ensure that they have not been damaged following a small impact, for example a shock absorber or a headlight that delivers a very accurate beam.

For such members likewise, inspection is expensive while any lack of inspection can turn out to be dangerous if they fail to perform their function at the appropriate moment.

### OBJECTS AND SUMMARY OF THE INVENTION

To this end, the present invention provides a device for monitoring a member that is stationary relative to a motor vehicle, the member having at least one position for proper operation, and a position in which it does not operate properly, the device comprising:

measurement means suitable for measuring a geometrical magnitude characteristic of the position of at least a portion of the member relative to another stationary member of the vehicle, and for delivering a signal;

comparator means connected to the measurement means and suitable for comparing the signal with a set of reference signals corresponding to at least one position for proper operation, said set being stored in the comparator means and supplying a positive result when the measured signal forms part of the set of reference signals, and otherwise supplying a negative result; and

warning means connected to the comparator means and suitable for triggering a malfunction alert when the result supplied by the comparator means is negative.

The term “geometrical magnitude characteristic of the position of at least a portion of the member” is used to mean a magnitude that reveals the state in which the member is to be found from a geometrical point of view, i.e. a magnitude that is spatially measurable, e.g. a distance, a thickness, an orientation, etc. This magnitude may be constituted, in particular, by the distance between a portion of the member and some other stationary member, its orientation, or its deformation.

Thus, if the member has been subjected to stress, e.g. in the event of an impact, and if it has deformed, e.g. beyond a certain threshold, it may no longer be in a proper position for good operation. Under such circumstances, the measurement means provide the comparator means with a signal leading to a negative result on comparison, thereby triggering a warning that informs the owner of the member being badly positioned and thus not operating properly, even when the deformation is not visible from the outside. Consequently, the owner knows that so long as a warning has not been issued, the member is in a position for proper operation.

Since the measured magnitude is characteristic of a position relative to some other stationary member of the vehicle, the frame of reference used is the vehicle, as opposed to any external frame of reference, as might be constituted by the ground on which the vehicle runs. Thus, no account is taken of changes of position that might apply to the vehicle as a whole, with the measurement that is performed being independent of any movement of the vehicle, and in particular of any tilting of the vehicle. This is particularly advantageous, since such variations in position are not characteristic of the member being in a position in which it will not operate properly.

A monitoring device of the invention may further comprise one or more of the following characteristics:

the measurement means comprise an optical fiber network and an optical sensor;

the measurement means comprise an electromagnetic field generator and a sensor;

the measurement means comprise an eddy current generator and a sensor;

the measurement means comprise an ultrasound generator and a sensor;

the measurement means comprise a Lamb wave generator and a sensor;

the measurement means comprise a part made of shape-memory alloy or a resistive strain gauge, and apparatus for measuring electrical resistivity;

the measurement means comprise fusible elements that break in the event of an impact liable to lead to malfunction of the member;

the warning means include means for deactivating the member; and

the set of reference signals is a continuous range of signals.

The invention also provides an assembly of a member and a device for monitoring the member as described above, in which the member is a system for detecting a danger.

Such an assembly may further comprise one or more of the following characteristics:

the detector system is an impact detector;

the detector system is an obstacle detector;

the member is a headlight;

the member is arranged at the front of the vehicle;

the member is arranged behind a bumper shield;

the member is arranged behind a vehicle fender;

the measurement means form part of the member;

the measurement means comprise firstly two substantially parallel electrically-conductive surfaces, and secondly an electronic circuit, thereby creating a capacitive system;

the measurement means further comprise a third electrically-conductive surface;

the assembly includes a contact sensor arranged in the vicinity of the member; and

the assembly includes two differential accelerometers, one of which is arranged on the member.

### BRIEF DESCRIPTION OF THE DRAWINGS

The invention will be better understood on reading the following description given purely by way of example and made with reference to the drawings, in which:

FIG. 1 is a diagram of a monitoring device in a first embodiment of the invention;

FIG. 2 is a diagram of a monitoring device in a second embodiment;

FIG. 3 is a diagram of a monitoring device in a third embodiment;

FIG. 4 is a diagram of a monitoring device in a fourth embodiment; and

FIG. 5 is a diagram of a monitoring device in a fifth embodiment.

### MORE DETAILED DESCRIPTION

A device of the invention is suitable for monitoring an impact detector system 10 installed on a motor vehicle, such as the system shown in FIG. 1.

The detector system 10 can detect an impact to which a bumper 12 is subjected. More precisely, it detects the deformations of an impact absorber 14 arranged behind a shield 16 and triggers, when deformation exceeds a certain threshold, the deployment of airbags in the cabin of the vehicle in order to protect the passengers.

The detector system 10 is secured to the vehicle in a position that enables it to operate properly, i.e. to detect deformations of the impact absorber 14. Nevertheless, it can happen that its position is modified as the result of an impact, without such a modification being visible from the outside if the impact is small. Depending on the modification that occurs, the system might then occupy a position that prevents it from operating properly.

A monitoring device serves to verify that the system 10 is in a position for proper operation. The monitoring device comprises measurement means 20 secured to a stationary member of the vehicle, i.e. a bumper beam 18, comparator means 22, and warning means 24.

In this embodiment, the measurement means 20 are constituted by an ultrasound transceiver which operates at regular intervals of time to measure the travel time of waves reflected on the detector system 10. Since the time measured depends on the distance traveled by the waves, it does indeed constitute a geometrical magnitude characteristic of the detector system 10, which magnitude represents the distance between said detector system and the transceiver 20.

The transceiver 20 is connected to the comparator means 22 and supplies them with signals representative of the measurements taken.

The comparator means comprise an electronics unit 22 capable of processing the signals it receives. The unit includes a memory in which a set of reference signals have previously been defined that correspond to positions in which the detector system 10 can operate properly.

The comparator means 22 are connected to the warning means 24 that are capable of alerting the driver, e.g. by signaling by means of a light or a sound. The warning means may optionally be connected to a service company.

The warning means may, in parallel, trigger deactivation of the detector system 10.

The electronics unit 22 is capable of comparing the signal received from the transceiver 20 with the set of reference signals.

So long as the result of the comparison is positive, i.e. so long as the received signal forms part of the set of reference signals, no action is triggered.

When the result of the comparison is negative, i.e. when the received signal does not form part of the set of reference signals, the unit 22 triggers the warning means 24.

In another embodiment that is not shown, the detector system is an optical detector arranged on the shield, or else it is a camera for identifying a risk of impacts against a pedestrian.

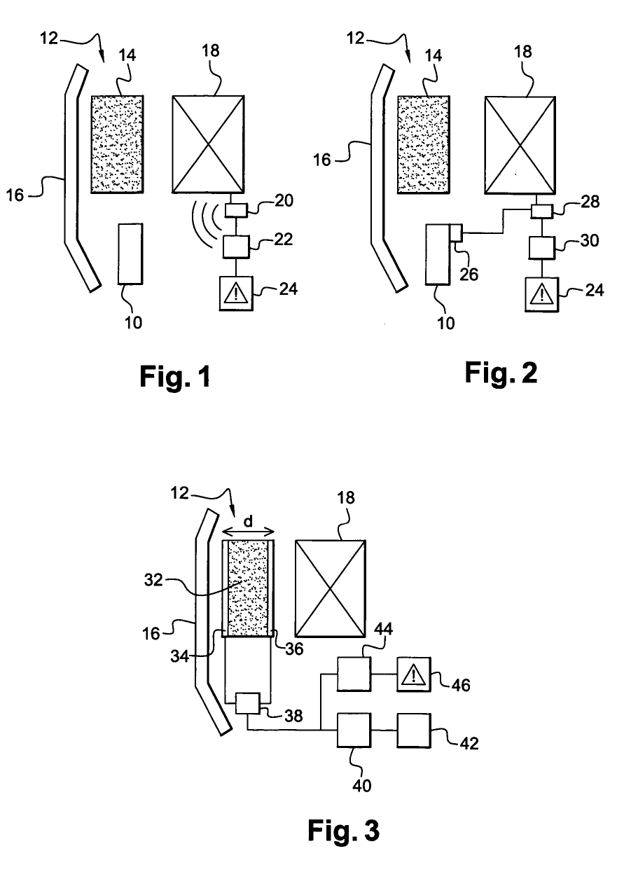

In another embodiment of the invention, shown in FIG. 2, the measurement means comprise a part 26 made of shape-memory alloy secured between the detector system 10 and a stationary bearing surface 27 secured to the beam 18. The alloy part 26 is connected to an instrument 28 for measuring its electrical resistivity. Since the part 26 is made of shape-memory alloy, it changes phase on being subjected to deformation, and that leads to a change in its resistivity. Comparator means 30 are suitable for processing the signal received from the instrument 28 and for comparing it with a set of reference signals, corresponding to a range of resistivities for which deformations of the alloy part 26 are representative of the detector system 10 being moved only a little, so that proper operation thereof is not impeded.

In the embodiment of FIG. 3, the measurement means are included in the detector system.

The detector system comprises an impact absorber or “crumple zone” 32 having inside and outside faces covered by two parallel layers 34 and 36 of electrically-conductive material forming conductive surfaces that are connected to an electronic circuit 38 capable of measuring the capacitance of the capacitive system formed by the two layers 34 and 36. The electronic circuit 38 is connected to means 40 for processing the measurement. Since the measured capacitance is representative of the distance d between the two conducive layers 34 and 36, itself characteristic of the intensity of an impact, the capacitive system is used as a system for detecting danger.

In the event of a violent impact, the processor means 40 detect that the change in distance d is characteristic of danger. It therefore triggers protection means 42 constituted in this example by airbags that deploy inside the cabin of the vehicle.

Optionally, the detector system includes a third electrically-conductive surface (not shown) arranged between the outside layer 34 and the shield 16, thereby electrically shielding the capacitive system so as to avoid unwanted interference from outside the vehicle.

The detector system constituted by the capacitive system 34, 36, and 38 and the processor means 40 is provided with a monitoring device of the invention comprising comparator means 44, which means are connected to an electronic circuit 38, and warning means 46 capable of alerting the driver when the detector system is not in a position for proper operation.

This monitoring device operates as follows. In the event of a small impact, the distance d might be modified but in a manner that is not dangerous, i.e. the impact suffered by the vehicle is followed neither by its airbag being deployed nor by its shield 16 being damaged. Under such circumstances, the comparator means 44 receive a signal that is representative of the distance d, and they compare said signal with a set of signals corresponding to distances for which the detector system is in a position for proper operation. If the received signal does not form part of said set of signals, then the comparator means 44 trigger the warning means 46.

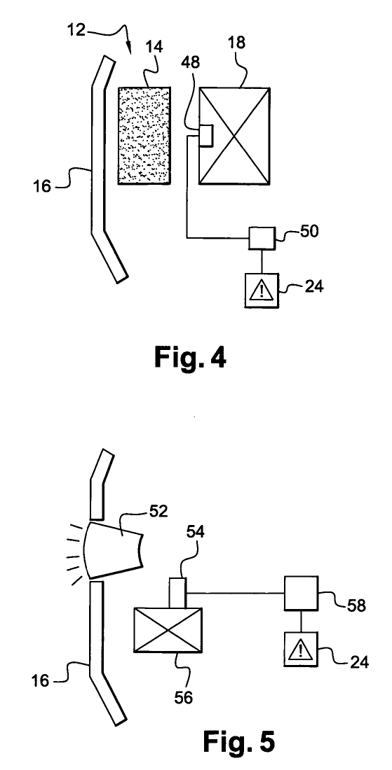

In another embodiment, shown in FIG. 4, the monitored member is not a detector system, but the impact absorber 14 itself, and it is verified that it has not been subjected to any deformation that would degrade its ability to absorb impacts. The measurement means are constituted by a contact sensor 48 arranged on a face of the bumper beam 18 that is in contact with the impact absorber 14 in order to measure the pressure exerted by the impact absorber 14 of the beam 18.

In the event of an impact, the impact absorber 14 is compressed against the beam 18, which leads to an increase in the pressure measured by the sensor 48. If the pressure received runs the risk of leading to the impact absorber 14 operating poorly, i.e. if the signal sent by the sensor 32 to the comparator means 50 does not form part of a set of signals corresponding to non-objectionable pressures, then an alert is issued by the monitoring means 24.

In another embodiment of the invention, shown in FIG. 5, the monitored member is a headlight 52. The monitoring device comprises a sensor 54, e.g. an optical sensor, measuring a magnitude that is characteristic of the orientation of the headlight 52, e.g. the distance between the sensor 54 and the headlight 52. The sensor is secured to a stationary member 56. When the headlight 52 is badly positioned, the comparator means 58 trigger the warning means 24.

It is particularly advantageous to monitor proper operation of the headlight 52, in particular if it is a xenon lamp which emits a beam that is very directional, and that must consequently be pointed very accurately.

Finally, it should be observed that the invention is not limited to the embodiments described above.

What is claimed is:

1. A device for monitoring a member that is stationary relative to a motor vehicle, the member having at least one position for proper operation, and a position in which it does not operate properly, the device comprising:
measurement means suitable for measuring a geometrical magnitude characteristic of the position of at least a portion of the member relative to another stationary member of the vehicle, and for delivering a signal;
comparator means connected to the measurement means and suitable for comparing the signal with a set of reference signals corresponding to at least one position for proper operation, said set being stored in the comparator means and supplying a positive result when the measured signal forms part of the set of reference signals, and otherwise supplying a negative result; and
warning means connected to the comparator means and suitable for triggering a malfunction alert when the result supplied by the comparator means is negative.

2. A monitoring device according to claim 1, in which the measured geometrical magnitude is the distance between a portion of the member and some other stationary member.

3. A monitoring device according to claim 1, in which the measurement means comprise an optical fiber network and an optical sensor.

4. A monitoring device according to claim 1, in which the measurement means comprise an electromagnetic field generator and a sensor.

5. A monitoring device according to claim 1, in which the measurement means comprise an eddy current generator and a sensor.

6. A monitoring device according to claim 1, in which the measurement means comprise an ultrasound generator and a sensor.

7. A monitoring device according to claim 1, in which the measurement means comprise a Lamb wave generator and a sensor.

8. A monitoring device according to claim 1, in which the measurement means comprise a part made of shape-memory alloy or a resistive strain gauge, and apparatus for measuring electrical resistivity.

9. A monitoring device according to claim 1, in which the measurement means comprise fusible elements that break in the event of an impact liable to lead to malfunction of the member.

10. A monitoring device according to claim 1, in which the warning means include means for deactivating the member.

11. A monitoring device according to claim 1, in which the set of reference signals is a continuous range of signals.

12. An assembly comprising a member and a device according to claim 1 for monitoring said member, in which the member is a system for detecting danger.

13. An assembly comprising a member and a device according to claim 1 for monitoring said member, in which the member is an impact absorber.

14. An assembly comprising a member and a device according to claim 1 for monitoring said member, in which the member is a headlight.

15. An assembly comprising a member and a device according to claim 1 for monitoring said member, in which the member is arranged behind a bumper shield.

16. An assembly comprising according to claim 12, in which the measurement means form part of the member.

17. An assembly comprising according to claim 16, in which the measurement means comprise firstly two substantially parallel electrically-conductive layers, and secondly an electronic circuit so as to create a capacitive system.

18. An assembly comprising according to claim 17, in which the measurement means further comprise a third electrically-conductive layer.

19. An assembly comprising according to claim 12, including a contact sensor arranged in the vicinity of the member.

20. An assembly comprising according to claim 12, including two differential accelerometers, one of which is arranged on the member.
